(19) United States
(12) Patent Application Publication
(10) Pub. No.: US 2014/0370354 A1
(43) Pub. Date: Dec. 18, 2014

(54) BATTERY PACK HAVING HEAT DISSIPATING SYSTEM

(71) Applicant: CHERVON (HK) LIMITED, Wanchai (HK)

(72) Inventors: Dezhong Yang, Nanjing (CN); Yuexiang Zhang, Nanjing (CN); Jianjun Shuang, Nanjing (CN); Hao Du, Nanjing (CN)

(73) Assignee: CHERVON (HK) LIMITED

(21) Appl. No.: 14/302,803

(22) Filed: Jun. 12, 2014

(30) Foreign Application Priority Data
Jun. 13, 2013 (CN) 201310234632.X

(51) Int. Cl. H01M 10/659; H01M 10/617; H01M 10/623

(52) U.S. Cl. CPC H01M 10/5089; H01M 10/5012; H01M 10/5008; H01M 2220/30
USPC 429/120

(57) ABSTRACT

A battery pack includes a phase change material, which implements temperature management of the battery pack by virtue of the heat dissipation action of the phase change material. The battery pack includes a plurality of battery cells, at least one of which is partially provided with a phase change material and brackets for supporting the plurality of battery cells. The phase change material is disposed at the maximum heat dissipating region of the battery cell, and the maximum heat dissipating region is a region partially extending from an intermediate position of the outer surface of the battery cell towards a positive pole end.

### RELATED APPLICATION INFORMATION

This application claims the benefit of CN 201310234632.X, filed on Jun. 13, 2013, the disclosure of which is incorporated herein by reference in its entirety.

### FIELD OF THE DISCLOSURE

The subject disclosure generally relates to a battery pack having a heat dissipating system and, more particularly, to a battery pack including a phase change heat dissipating material.

### BACKGROUND

Hand-held electrical tools and gardening instruments using a rechargeable battery are extensively used in factory, farm, lawn, and/or household applications. Since these tools and instruments use a plurality of battery cells, the plurality of battery cells are generally encapsulated into a battery pack, and then the batter pack is coupled and mounted to the tools and instruments. Due to the existence of internal resistance, heat will be generated when the battery is charged or discharged. It is difficult to dissipate the heat because these rechargeable batteries are compactly encapsulated within an housing, bracket of the battery group, and/or the battery pack. When the heat accumulates to a certain degree, it will affect the efficiency and service life of the battery group/battery pack. Therefore, to prevent excessively high and quick temperature rise of the battery pack, it is usual to take a discharge protection measure to timely terminate the discharge. In hand-held tools or gardening instruments using a rechargeable battery as the source of energy, the larger the discharging current of the battery is, the higher the temperature of the battery is, thus the temperature rises more quickly. Particularly upon the discharge of a large current, if the heat is not dissipated timely and effectively, the temperature will rise to an extremely high temperature in a short time period so that an over-temperature/discharge protection mechanism is triggered and the machine frequently executes shutdown protection measure, thereby causing interruption and trouble in operation and affecting the whole operation of the tool.

At present, conventional heat-dissipating modes for the battery pack comprises the mode of dissipating heat by using air convection and the mode of using a heat sink to conduct heat out of the battery pack and then lowering the temperature by using the convection action of surrounding air. However, the two methods requires additional provision of a convection wind channel, a fan or a heat sink in the battery pack, which increases the size of the battery pack and makes the structure more complicated.

A phase change material (PCM) stores heat by using a property of the material and absorbs or discharges a lot of heat when the material is subjected to phase change, and has advantages such as a high heat storage density, a small size and a high thermal efficiency. The material is less corrosive, non-toxic and highly stable, and has already been extensively applied to constant temperature control field in aspects such as solar energy utilization, waste heat recovery, building heat preservation and air conditioning energy saving, and is an important heat storage manner at present.

### SUMMARY

Generally described hereinafter is a battery pack having a heat dissipating system, including a phase change heat dissipating material, particularly a battery pack used for hand-held electrical tools such as electrical drills, electrical wrenches, electrical screwdrivers, electrical hammer drills, electrical circular saws, electrical sander, electrical wood miller, and gardening tools such as electrical mower, electrical grass trimmer, electrical shears, electrical branch trimmers and electrical saws.

More particularly, an exemplary described battery pack, includes:

a plurality of battery cells wherein at least one battery cell of the plurality of battery cells is partially provided with a phase change material; and

at least one bracket for supporting the plurality of battery cells;

wherein the phase change material is disposed at the maximum heat dissipating region of the at least one battery cell, and the maximum heat dissipating region is a region partially extending from an intermediate position of the outer surface of the at least one battery cell towards a positive pole end of the at least one battery cell.

Preferably, the phase change material is configured to be annular and sleeved on the outer surface of the at least one battery cell.

Preferably, the phase change material is encapsulated on the at least one battery cell by an encapsulating layer.

Preferably, the phase change material disposed on the at least one battery cell has a weight of 1.5 g-3.5 g.

Preferably, the phase change material disposed on the at least one battery cell has a density of 1 kg/l-2 kg/l.

Preferably, the maximum heat dissipating region is located at a position of two-thirds in a longitudinal direction of the at least one battery cell extending from the intermediate position of the outer surface of the at least one battery cell towards the positive pole end.

Preferably, the maximum heat dissipating region is located at a position of three-fourths in a longitudinal direction of the at least one battery cell extending from the intermediate position of the outer surface of the at least one battery cell towards the positive pole end.

Preferably, the phase change material is further provided at a region extending towards a negative pole end and symmetrical with the maximum heat dissipating region with the intermediate position of the at least one battery cell considered as a symmetrical axis.

Preferably, the phase change material includes a fibrous material with a content of 0.5%-5%.

Preferably, the phase change material is filled at least in a gap between the plurality of battery cells or a gap between the plurality of battery cells and the bracket.

Preferably, the battery pack further includes at least two backing plates, and the phase change material is filled between the backing plates.

Preferably, the backing plates support the plurality of battery cells and seal the phase change material.

Preferably, the at least two backing plates are provided with additional sealing material.

Preferably, the brackets seal the phase change material.

By providing the phase change material at a region of the battery cell with the largest heat generation and the quickest temperature rise, the battery pack according to the present invention substantially improves the heat dissipating effect of the phase change material for the battery pack, and can slow down the temperature rise of the battery pack and prolong the service life of the battery pack particularly when the battery pack is applied to a hand-held tool or gardening tool powered by the battery pack.

### BRIEF DESCRIPTION OF THE DRAWINGS

FIG. 1 is a schematic view of an exemplary battery pack constructed according to the description that follows.

FIG. 2 is a schematic view of the assembled battery pack of FIG. 1.

FIG. 3 is a schematic diagram of a maximum heat dissipating region after the battery cells are sleeved with a phase change material.

FIG. 4a is a first structural schematic view of a battery group in a battery pack according to the description which follows.

FIG. 4b is a second structural schematic view of a battery group in a battery pack according to the description which follows.

FIG. 5 is a schematic view of the battery pack of FIG. 4 as viewed from another perspective.

FIG. 6 is a schematic view of the battery pack of FIG. 4 before being assembled.

FIG. 7 is a schematic view of an exemplary battery pack wherein a phase change material is duly encapsulated.

FIG. 8 is a schematic view of a battery cell sleeved with a phase change material according to the description which follows.

FIG. 9a is a schematic view of an exemplary battery pack before encapsulation according to the description which follows.

FIG. 9b is a schematic view of an exemplary battery pack after encapsulation according to the description which follows.

FIG. 10 is a schematic view of the phase change material according to the description which follows.

### DETAILED DESCRIPTION

Generally, the following describes a battery pack including a heat dissipating structure, which is a phase change material, which is intended to provide temperature management of the battery pack by virtue of heat dissipation of the phase change material. The figures illustrate exemplary battery packs which are particularly adapted for hand-held electrical tools such as electrical drills, electrical wrenches, electrical screwdrivers, electrical hammer drills, electrical circular saws, electrical sander, electrical router, and gardening tools such as lawn mower, grass trimmer, electrical shears, hedge trimmers and electrical saws. For ease of description, these hand-held electrical tools and gardening tools are collectively called power tools. The power tools include a battery pack with a given nominal voltage, e.g., a nominal voltage of at least 18V or 36V, and the electrical tools are driven by these battery packs. As will be appreciated, the described battery packs need not be limited to the above power tools, nor limited to the aforesaid designated nominal voltage. In fact, the teachings provided herein can be used to adapt a battery pack for use in connection with any type of cordless power tool powered by a battery pack.

In some embodiments, the battery pack includes rechargeable batteries which may be lithium chemical batteries, for example, lithium ion batteries, particularly 18650 model cylindrical lithium ion batteries often used in the field of power tool. In some embodiments, the battery pack may include at least one rechargeable battery cell, or a plurality of rechargeable battery cells, which depends on the desired nominal values of the battery pack. In this regard, battery packs with different nominal values may be implemented by connecting a plurality of rechargeable battery cells in series and/or in parallel. Certainly, the rechargeable battery cells may be configured to employ other lithium chemical battery with lithium substrate, or any rechargeable batteries with other chemical substrates, such as nickel-cadmium or nickel-hydrogen rechargeable batteries.

As further shown in the figures, the battery pack may have, but is not required to have, a to square, barrel, tower or other shape. Generally, the battery pack includes a housing, at least one battery cell, an electronic device for performing internal and external control and protection measure, a terminal member connected to an external charger or power tool, a battery cell connection mechanism, and a phase change material disposed adjacent to at least one battery cell. In some embodiments, the battery pack further includes a support structure for supporting the at least one battery cell. Obviously, the internal configurations of the battery pack such as the housing, the at least one battery cell, the electronic device for performing internal and external control and protection measure, the terminal member connected to an external charger or power tool and the battery cell connection mechanism are universal configurations and therefore are not detailed in the description and figures for the sake of brevity. The configuration for the internal heat dissipating structure and the phase change material for dissipating the heat of the battery cell according will therefore be described in detail with reference to figures. This configuration may solve heat dissipation problem caused when the battery pack is charging or discharging, particularly when the battery pack is discharging to supply electrical energy to the power tool, and solve problems such as distribution of the battery cells in the battery pack and compactness of the battery pack when the phase change material is used.

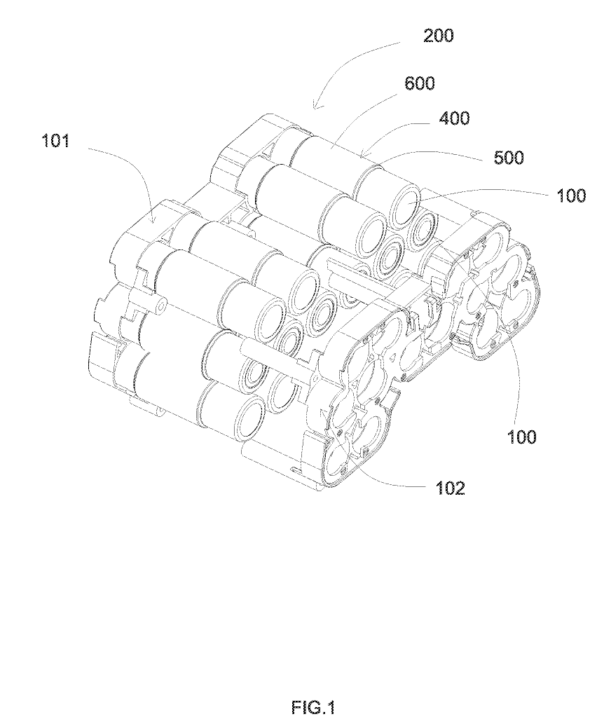

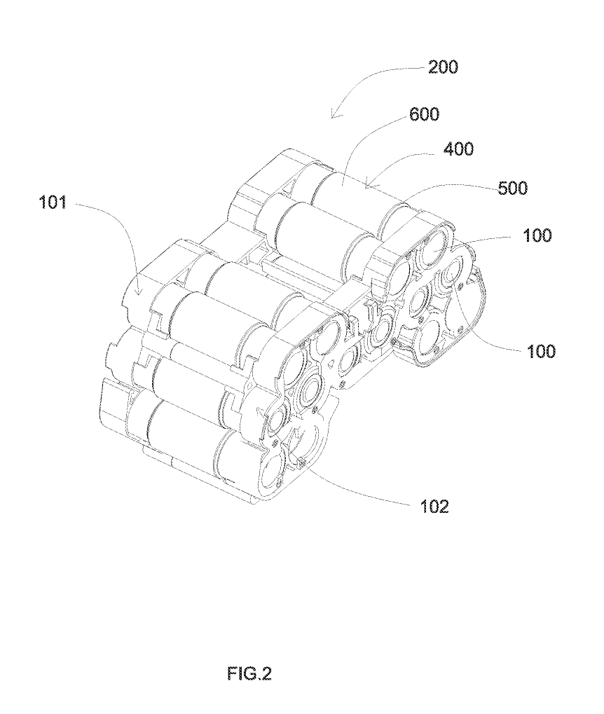

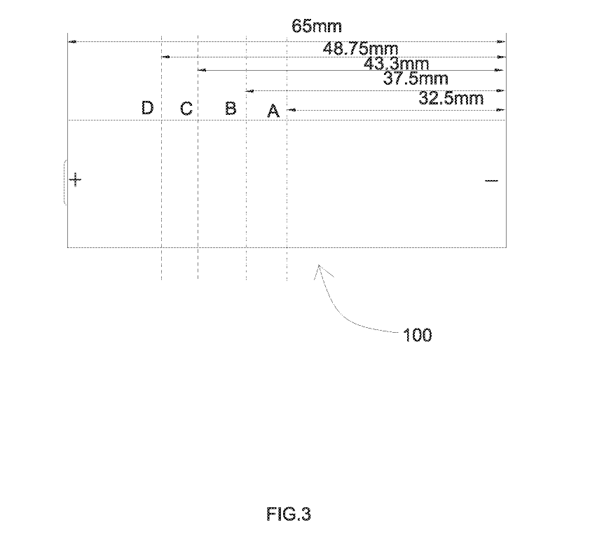

An exemplary battery pack includes a housing and at least one lithium ion battery cell 100. As more clearly shown in FIGS. 1 and 2, the battery pack includes a plurality of battery cells 100 which are arranged compactly with respect to one another to form a battery group 200. The battery pack further includes a bracket 101 and a bracket 102 which are distributed at both ends of the plurality of battery cells 100 and the resulting battery group 200, and disposed in a plane extending perpendicular to a longitudinal direction of the arranged plurality of battery cells 100 to support the plurality of battery cells 100 and the resulting battery group 200, and forms the battery group 200 as a compact structure via a mechanical fixing structure such as screw or snap-fitting. The battery cell 100 is partially provided with a phase change material 500 which is configured to match an annular structure of an outer profile of one or more of the battery cells 100 and sleeved around a maximum heat dissipating region of the battery cell 100. The maximum heat dissipating region is defined at a region partially extending from an intermediate position A of an outer surface of the battery cell 100 towards a positive pole end, as shown in FIG. 3.

As shown in FIG. 3, the battery cell 100 has a length of about 65 mm and a diameter of about 18 mm. A region with the quickest temperature rise upon the charge or discharge of the battery cell is located at a region 5 mm offset from the middle of the outer surface of the battery cell towards the positive pole end, that is to say, a region defined by extending 5 mm from the intermediate position A (a position at about 32.5 mm) of the longitudinal direction of the battery cell 100 towards the positive pole end to a position B (a position at about 37.5 mm) is a region of the battery cell in which the temperature rises most easily and most quickly to an extreme temperature. Therefore, in some embodiments, this region is preferably the maximum heat dissipating region of the battery cell 100, and the phase change material 500 is sleeved around this region. To achieve a more desirable heat dissipating effect, in some embodiments, the phase change material may be sleeved at a region defined by extending a larger distance from the intermediate position A (a position at about 32.5 mm) of the longitudinal direction of the battery cell 100 towards the positive pole end to a position C (a position at about 43.3 mm) at two-thirds of the whole length of the battery cell 100 in the longitudinal direction, or at a region defined by extending a larger distance from the intermediate position A (a position at about 32.5 mm) of the longitudinal direction of the battery cell 100 towards the positive pole end to a position D (a position at about 48.75 mm) at three-fourths of the whole length of the battery cell 100 in the longitudinal direction. At this time, these positions are preferably regarded as the maximum heat dissipating region of the battery cell 100.

As shown in FIGS. 1 and 2, each annular phase change material 500 is made of phase material particulates and has a shape adapted for the outer profile of the battery cell 100. In this embodiment, the phase change material is constructed in a circular ring shape with a thickness of 0.8-1 mm and a length of 28-32 mm. The specific dimensions of the phase change material may be adjusted according to the dimensions of the battery cell 100 and the arrangement of the battery cells, and the phase change material is sleeved around the battery cells 100 by a mounting tool or in other manners. To achieve a more desirable heat dissipating effect, the phase change material 500 may be disposed at a region extending from the intermediate position A of the battery cell 100 towards a negative pole end until a position symmetrical with position B, position C or position D with A as a symmetry point. That is to say, the phase change material 500 may be provided at a region symmetrical with the intermediate point A of the battery cell as the symmetry point and extending towards the negative pole end. As shown in FIGS. 1-3, the phase change material 500 is positioned on a predetermined region extending from an intermediate position of each battery cell towards pole ends of each battery cell and the predetermined region is a region of the battery cell with the largest heat generation and the quickest temperature rise.

The maximum heat dissipating region of the battery cell 100 is sleeved with the phase change material 500 to form a coverage region 400. To prevent the phase change material 500 from leaking when phase changing, an encapsulating layer 600 is mounted on the coverage region 400. The encapsulating layer 600 may only seal the coverage region or seal the outer cylindrical profile of the whole battery cell. The encapsulating layer 600 is made of an insulating material, e.g., a heat-sealing tube, and is preferably an encapsulating layer made of the same material as the encapsulating material of a main body of the battery cell 100.

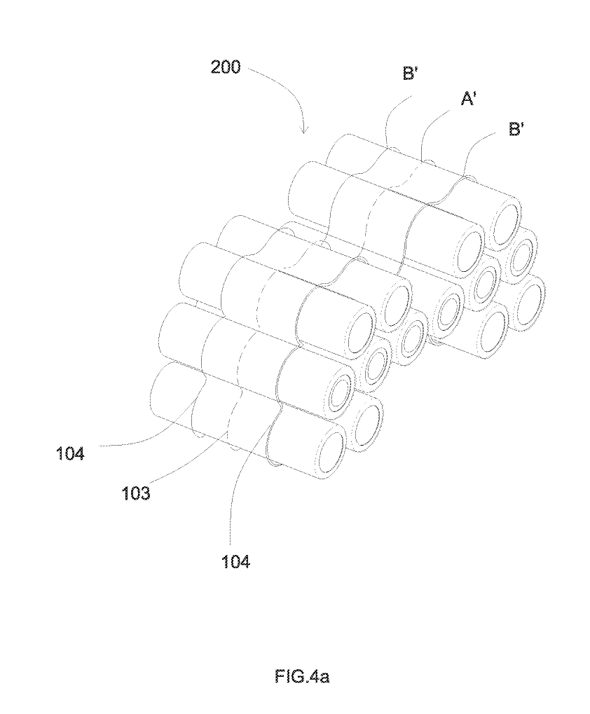

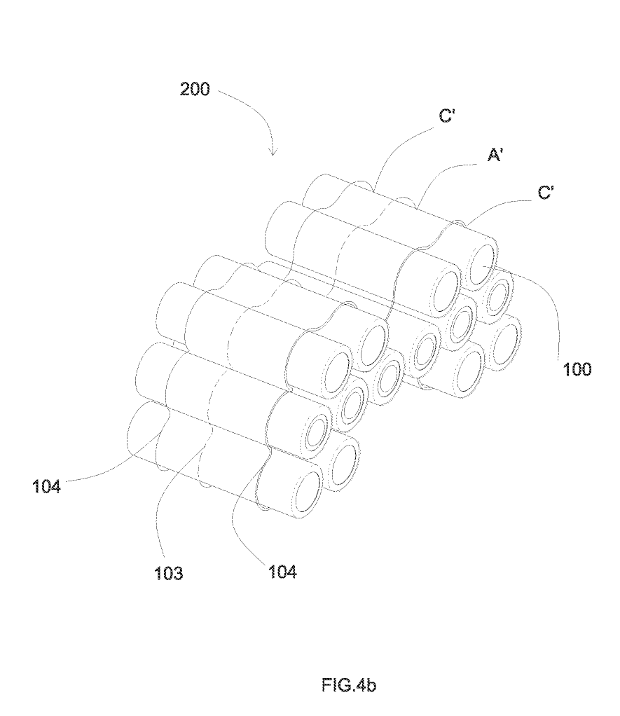

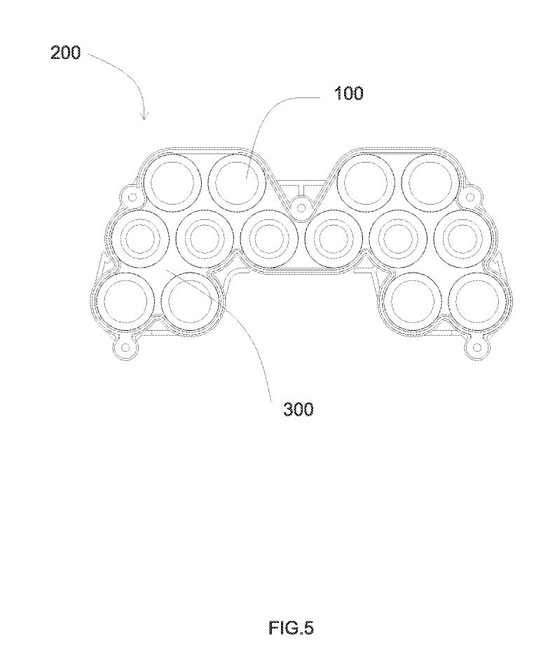

FIG. 4a, FIG. 4b, FIG. 5, and FIG. 6, illustrate a battery pack having a plurality of lithium ion battery cells 100 which may be 18650 model cylindrical lithium ion batteries often used in the field of power tools. The battery cells 100 are arranged compactly to one another to form a battery group 200. A gap 300 is formed between the adjacent battery cells 100. The phase change material 500 is filled in a partial space of the gap 300 and adjoins to the outer surface of the battery cell 100 at its maximum heat dissipating region. The maximum heat dissipating region is defined at a region partially extending from the intermediate position A of the outer surface of the battery cell 100 towards the positive pole end. The maximum heat dissipating region is shown as FIG. 3, which is a region defined by extending 5 mm from the intermediate position A (a position at about 32.5 mm) of the longitudinal direction of the battery cell 100 towards the positive pole end to a position B (a position at about 37.5 mm). This region may also be a region defined by extending a larger distance from the intermediate position A (a position at about 32.5 mm) of the longitudinal direction of the battery cell 100 towards the positive pole end to a position C (a position at about 43.3 mm) at two-thirds of the whole length of the battery cell 100 in the longitudinal direction, or a region defined by extending a larger distance from the intermediate position A (a position at about 32.5 mm) of the longitudinal direction of the battery cell 100 towards the positive pole end to a position D (a position at about 48.75 mm) at three-fourths of the whole length of the battery cell 100 in the longitudinal direction.

As shown in FIG. 6, this battery pack further includes a bracket 101 and a bracket 102 which are respectively formed at both ends of the plurality of battery cells 100 and the resulting battery group 200, and disposed in a plane extending perpendicular to a longitudinal direction of the arranged plurality of battery cells 100 to support the plurality of battery cells 100 and the resulting battery pack 200. The brackets, together with an integral encapsulating member 110, encapsulate the battery group 200 into a compactly arranged structure.

This battery pack further includes a backing plate 103 and a backing plate 104. The backing plate 103 and backing plate 104, like the bracket 101 and the bracket 102, are disposed in a plane extending perpendicular to the longitudinal direction of the arranged plurality of battery cells 100. The backing plate 103 and backing plate 104 respectively have bores 105 shaped to match the outer profile of the battery cells 100. As such, the backing plate 103 may be mounted at an intermediate position of the battery group 200, namely, at a position of a cross section A′ formed by the position A when the battery cells are arranged. To achieve a desirable heat dissipating effect, the backing plate 103 may also be mounted at a position extending a certain distance from the cross section A′ formed by the position A when each battery cell is arranged towards the negative pole end of the battery cell. Particularly, the distance may be 1-5 mm. The mounting of the backing plate 104 and its sealing for the phase change material are described below in detail.

When all battery cells 100 of the battery group 200 are arranged opposite to one another, the backing plate 104 is mounted at a position of a cross section B′ formed by the position B, or at a position of a cross section C′ formed by the position C when the battery cells 100 are arranged. The maximum heat dissipating region is defined at a region between the backing plate 103 and backing plate 104. As such, since the battery group 200 include battery cells arranged in two opposite directions, two positions of cross sections B′, C′ in the direction of the positive pole end and in the direction of the negative pole end appear in the same battery group 200, and therefore two maximum heat dissipating regions are defined. The phase change material 500 is filled in a portion of a gap 300 defined by the two regions. In this case, the backing plate 103 may be omitted, and only two backing plates 104 are disposed, and the phase change material 500 is filled between the two backing plates 104, thus the two backing plates 104 are used to seal the phase change material 500. It may be appreciated that the backing plate 104 may be mounted at a position of a cross section (not shown in the figures) formed by the position D when the battery cells 100 are arranged.

When the battery cells 100 in the battery group 200 are arranged in the same direction, the backing plate 104 may be mounted at a position of the cross section B′ formed by the position B, or a position of the cross section C′ formed by the position C, or a position of the cross section formed by the position D (not shown in the figures) when the battery cells 100 are arranged. In such arrangement, the maximum heat dissipating region is defined at the region between the backing plate 103 and the backing plate 104, the phase change material 500, after being processed into powder or particulates by manufacture process, is filled in a portion of the gap 300 defined by the region, and the phase change material is in direct contact with the maximum heat dissipating region of the outer surface of each battery cell and sealed by the backing plate 103 and backing plate 104. It may be appreciated that the backing plate 104 may also be directly mounted on the bracket 102, and the bracket 102 implements sealing of the phase change material while supporting the battery cells and the battery group.

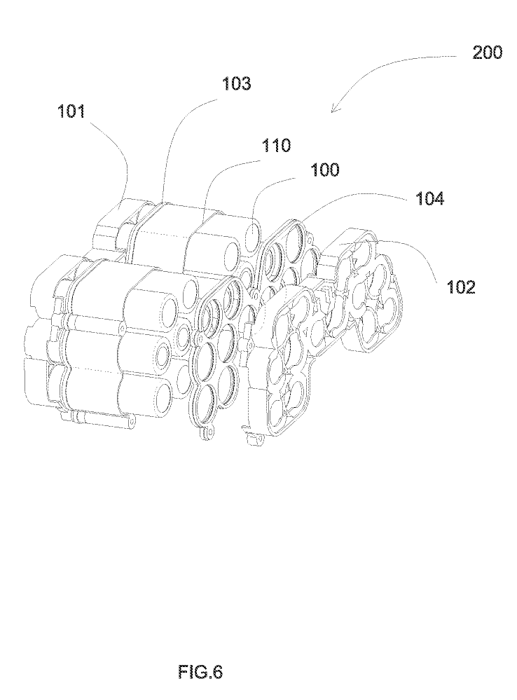

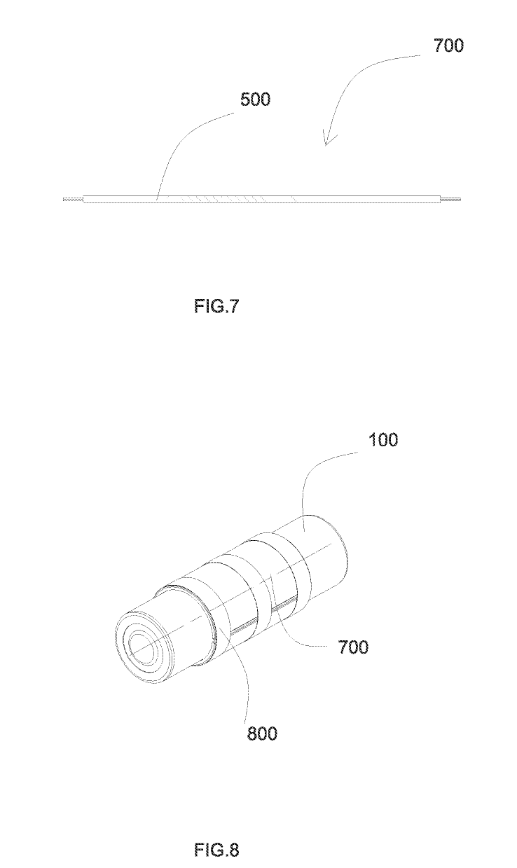

FIG. 7 and FIG. 8 show a battery pack that includes a plurality of battery cells 100. These battery cells 100 are arranged compactly to form a battery group 200. The battery pack further includes a bracket 101 and a bracket 102 which are distributed at both ends of the plurality of battery cells 100 and the resulting battery group 200 to support the plurality of battery cells 100 and the resulting battery pack 200, and encapsulate the battery group 200 as a compactly arranged structure. The phase change material 500, after being uniformly encapsulated by an insulating material, constitutes a phase change material encapsulation body 700, and is fixed to the maximum heat dissipating region of the battery cells 100 by using an adhesive tape 800, two-sided adhesive tape or an adhesive. The maximum heat dissipating region is defined as shown in FIG. 3, the maximum heat dissipating region is a region defined by extending 5 mm from the intermediate position A (a position at about 32.5 mm) of the longitudinal direction of the battery cell 100 towards the positive pole end to a position B (a position at about 37.5 mm). This region may also be a region defined by extending a larger distance from the intermediate position A (a position at about 32.5 mm) of the longitudinal direction of the battery cell 100 towards the positive pole end to a position C (a position at about 43.3 mm) at two-thirds of the whole length of the battery cell 100 in the longitudinal direction, or a region defined by extending a larger distance from the intermediate position A (a position at about 32.5 mm) of the longitudinal direction of the battery cell 100 towards the positive pole end to a position D (a position at about 48.75 mm) at three-fourths of the whole length of the battery cell 100 in the longitudinal direction. Furthermore, the phase change material encapsulation body 700 may be disposed at a region extending from the intermediate position A of the battery cell 100 towards the negative pole end until a position symmetrical with position B, position C or position D with position A as a symmetry point. That is to say, the phase change material encapsulation body 700 may also be provided at a region symmetrical with the maximum heat dissipating region with the intermediate point A of the battery cell as the symmetry point and extending towards the negative pole end. FIG. 8 shows a single battery cell sleeved with the phase change material encapsulation body.

As shown in FIG. 7 and FIG. 8, the phase change material 500, having a weight of 2.5 g and a density of approximately 1 kg/l, is evenly encapsulated by an insulating encapsulating body, e.g., a plastic bag, to form the phase change material encapsulation body 700. The phase change material encapsulation body 700 has a thickness of 0.8-1 mm and a length of 28-32 mm. The specific dimensions may be adjusted according to the dimensions and the arrangement of the battery cells 100. The phase change material encapsulation body 700 is encapsulated at both ends and encapsulates the maximum heat dissipating region on the outer surface of the battery cell 100 and the region symmetrical with the maximum heat dissipating region with the intermediate point A of the battery cell as the symmetry point and extending towards the negative pole end, by using an adhesive tape, two-sided adhesive tape or an adhesive. With such arrangement, the plurality of battery cells 100 are assembled and fixed as the battery group 200 and mounted in the housing of the battery pack in a manner as shown in the first embodiment.

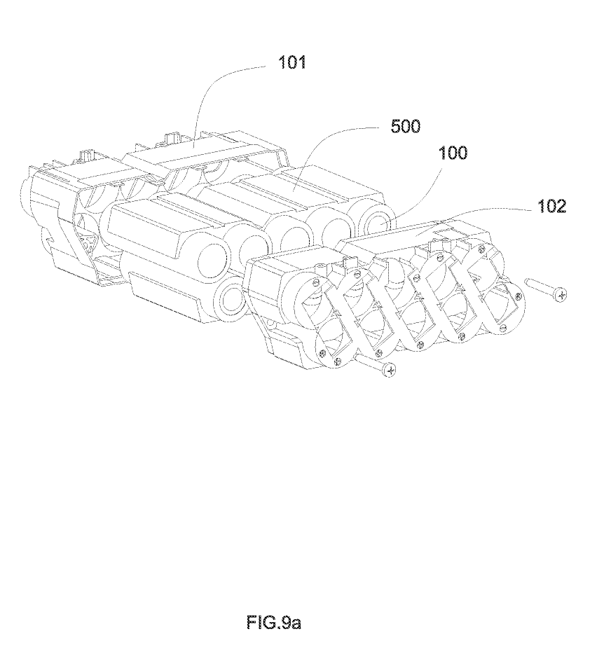

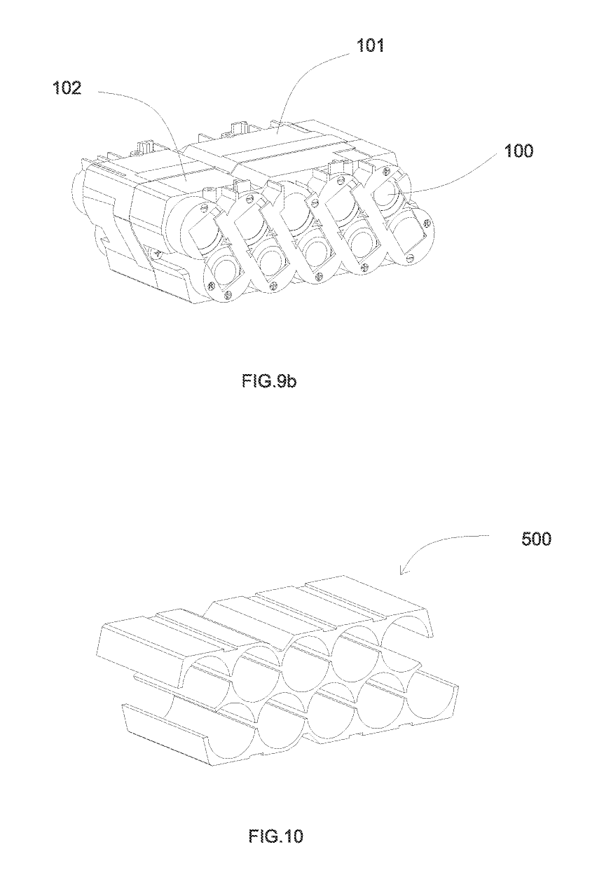

FIG. 9a, FIG. 9b and FIG. 10 illustrate a battery pack including a plurality of lithium ion battery cells 100 which are arranged compactly to form a battery group. A gap is formed between the adjacent battery cells 100 and between the battery cells 100 and left and right brackets 101, 102, and the phase change material 500 is filled in a portion of the space of the gap and disposed adjacent to the outer surface of the battery cell 100 at its maximum heat dissipating region. The maximum heat dissipating region is defined at a region partially extending from the intermediate position A of the outer surface of the battery cell 100 towards the positive pole end. As shown in FIG. 3, the maximum heat dissipating region is a region defined by extending 5 mm from the intermediate position A (a position at about 32.5 mm) of the longitudinal direction of the battery cell 100 towards the positive pole end to a position B (a position at about 37.5 mm). This region may also be a region defined by extending a larger distance from the intermediate position A (a position at about 32.5 mm) of the longitudinal direction of the battery cell 100 towards the positive pole end to a position C (a position at about 43.3 mm) at two-thirds of the whole length of the battery cell 100 in the longitudinal direction, or a region defined by extending a larger distance from the intermediate position A (a position at about 32.5 mm) of the longitudinal direction of the battery cell 100 towards the positive pole end to a position D (a position at about 48.75 mm) at three-fourths of the whole length of the battery cell 100 in the longitudinal direction, or the phase change material 500 is further provided at a region symmetrical with the maximum heat dissipating region with the intermediate point A of the battery cell 100 as the symmetry point and extending towards the negative pole end.

As shown in FIG. 9b, the brackets 101, 102 may be preferably made of a heat-conducting material, e.g., metallic aluminum, or silicon carbide. The brackets 101, 102 are engaged and fixed in a mechanical manner such as screw to encapsulate the duly disposed battery cells 100 and the phase change material 500. The brackets are in full contact with the phase change material to well conduct heat generated by the battery cells and achieve a good heat dissipating effect, and meanwhile achieve the sealing of the phase change material 500 and prevent leakage of the phase change material when the phase change material is subjected to phase change.

The surface of the battery cells 100 may also be coated with a material such as heat-conducting glue, or heat-conducting resin to increase a contact area between the phase change material 500 and the battery cells 100, and enhance the heat exchange efficiency between the phase change material 500 and the battery cells 100. The phase change material may be added with a highly heat-conducting material such as aluminum nitride, carbon fiber or graphite to improve the phase change heat-dissipating efficiency and effect.

The phase change material 500 used in the battery pack is preferably an organic composite phase change material with small corrosion, non-toxicity and a stable phase change form, particularly a phase change material with polyethylene glycol as a carrier and with silica gel solution added as a nanometer supporting structure, having a phase change enthalpy reaching 150 to 350 J/g. Upon the phase change, the phase change material remains invariable in morphology, and will not flow to cause a serious leakage of the phase change material under the sealing of the encapsulating structure and sealing layer. The flame retardance of the phase change material may be substantially improved after a certain proportion of a composite flame retardant of graphite and ammonium polyphosphate is added to the phase change material. Due to the heat exchange action, graphite, particularly expandable graphite, can also improve the heat exchange efficiency of the phase change material.

The phase change material 500 used in the battery pack may also be an inorganic salt phase change material, for example a mixture including 80%-90% sodium acetate, 1%-5% sodium dodecyl benzene sulfonate, 1%-5% carboxymethyl cellulose and 1%-5% sodium carbonate, or may be a mixture including approximately 50%-99% polyethylene glycol and 1%-10% cellulose diacetate (other thickeners such as chitosan may be used to replace cellulose diacetate). The mixture is crushed and mixed to obtain the desired phase change material which is mounted on each battery cell after being processed into shape or encapsulated into an encapsulation body. The component and the corresponding proportions may also be changed according to requirements.

The phase change material 500 may also be other phase change materials, including organic solid-liquid phase change materials such as fatty hydrocarbons, polyethylene polyols or polyene alcohols, e.g., paraffin, or organic solid-solid phase change materials, such as polyhydric alcohols or macromolecules, e.g., pentaerythritol (PE), trimethylolethane (PG) and neopentyl glycol (NPG), or other organic composite phase change materials, e.g., paraffin/graphite composite phase change material, paraffin/polyvinyl alcohol composite phase change material, or inorganic phase change materials, e.g., hydrous salts or molten salts.

The phase change material may be added with a highly heat-conducting material consisting of at least one of graphite, carbon fibers, foam metal, nanometer aluminum nitride, nanometer metal particle, nanometer metal oxide particle and metal chips to increase thermal conductivity of the composite phase change material as well as the heat dissipating efficiency of the phase change material.

The phase change material may also be added with a fibrous material such as natural or artificial fibrous material like acetate fiber, polyester fiber, glass fiber, metallic fiber, cotton fiber or plant fiber, preferably glass fiber, wherein the content of the fibrous material is 0.5%-5%, preferably 0.5%-1%. A specific fabrication method includes the steps of mixing phase change material powder and the fibrous material by a certain proportion, stirring it evenly to serve as a raw material, and processing it into a phase change material of a desired shape by injection molding process. With added fibrous material, the phase change material has an effectively improved strength and can be more easily shaped and is not apt for break.

The phase change material provided on the battery cell 100 is preferably certain in weight. Each battery cell 100 is sleeved or encapsulated with the phase change material which is 1.5-3.5 g in weight, 1-2 kg/l in density and evenly distributed on the outer surface of the battery cell. Preferably, when each battery cell 100 is sleeved or encapsulated with 2-3 g phase change material, the phase change material can be evenly distributed by an encapsulating structure or sealing layer, and maintains a good uniform form upon the phase change to achieve an optimal heat dissipating effect. Meanwhile, such arrangement can also keep the outer shape and size of the encapsulated battery cells and the resulting battery group form increasing greatly and still allows for a compact structure.

In the battery pack of the present invention, the phase change material 500 does not cover the outer profile of the whole battery cell 100, and instead, is distributed at the portion of the battery cell with the quickest heat generation and the highest temperature rise, namely, at the maximum heat dissipating region. Such arrangement, on the one hand, can maintain the compact dimensions of the battery cell including the phase change material, the battery group and the battery pack, with simple structure and easy installation, and on the other hand, due to limitations of total amount and density of the phase change material adapted for each battery cell, the phase change material may be distributed uniformly and meanwhile maintain excellent resistance against flow. Even in the event of flow or leakage, the phase change material will not flow or leak to both ends and positive and negative pole positions of the battery cells 100 and thereby cause battery fault because the phase change material does not cover the outer profile of the whole battery cell.

When the temperature of the battery cells 100 rises to about 40 degrees centigrade upon charge or discharge, the phase change material 500 begins to act to slow down temperature rise of the battery pack, and finally keeps the temperature of the battery cells 100 below 70 degrees centigrade upon completion of the discharge, thereby achieving the purpose of heat dissipation. By cooperating with the quick heat dissipation upon charge, it is ensured that the battery pack has a certain discharge duration and will not continuously perform over-temperature protection. On the occasion of large-current discharge, particularly on the occasion of using a gardening tool powered by a battery pack with a nominal voltage of 36V or 56V, the battery pack can be ensured to continuously work in a certain discharge duration, the service life of the batteries is improved, and infinite cyclic continuous powering for the power tool by the battery pack is made possible.

When the battery cells are discharged, the heat generated by them is directly proportional to a magnitude of the discharge current. After charge or discharge certain times, the internal resistance of the battery pack increases and will further increases the heat generated by the battery cells upon charge or discharge. TABLE 1 below illustrates test results of a single battery cell sleeved with an annular phase change material and the resulting battery group. After the battery cell 100 is sleeved with the phase change material at the maximum heat dissipating region and the symmetrical maximum heat dissipating region, the discharge current is increased at 25 degrees centigrade, and after 300 times of charge and discharge cycle, an actual maximum surplus battery capacity of the battery cell is apparently higher than an actual maximum surplus battery capacity of a battery cell without the phase change material. A battery group of 7 battery cells arranged in series and then connect in parallel is taken as an object of the experiment whereupon the nominal voltage of the battery pack is 56V, called 14S2P, and the battery pack is charged and discharged cyclically with 10 A discharge current under the condition of 35 degrees centigrade. As seen, the battery group constructed to the descriptions set forth herein can still maintain 73% capacity after 500 times or even 700 times of charge and discharge cycle, whereas the battery group without capsulated phase change material is already damaged after 188 times of charge and discharge cycle and a measured actual capacity of the battery cells is already lower than 60%, even lower.

TABLE 1

| | Test content | | | |
|---|---|---|---|---|
| | | | Times of | |
| | | | charge and | Actual |
| | Discharge | Test | discharge | surplus |
| Test object | current | temperature | cycles | capacity |
| A single lithium battery | 10A | 25° C. | 300 | 72% |
| cell | | | | |
| A single lithium battery | 11A | 25° C. | 300 | 88% |
| cell encapsulated with a | | | | |
| phase change material | | | | |
| 56 V lithium battery | 10A | 35° C. | 188 | — |
| pack (14S2P) | | | | |
| 56 V lithium battery | 10A | 35° C. | 500 | 85% |
| pack (14S2P) | | | | |
| encapsulated with a | | | | |
| phase change material | | | | |
| 56 V lithium battery | 10A | 35° C. | 700 | 73% |
| pack (14S2P) | | | | |
| encapsulated with a | | | | |
| phase change material | | | | |

In some embodiments, the bracket 101 and the bracket 102 may be a plastic member, aluminum nitride or other insulating materials with a high thermal conductivity, and thus they themselves are also good thermal conductors to dissipate the heat of the battery cells 100. The bracket 101 and the bracket 102 may further have certain elasticity to maintain a certain tension space to offset vibration for the battery cells 100 and the battery group 200 from the internal or external.

Likewise, the backing plate 103 and the backing plate 104 may be a plastic member, aluminum nitride or other insulating materials with a high thermal conductivity, and thus they themselves are also good thermal conductors to dissipate the heat of the battery cells 100.

The battery cell 100 may also be configured to be flat, rectangular or have other regular shapes. The phase change material 500 may also be provided on these non-cylindrical battery cells, and evenly distributed on the maximum heat dissipating region of these battery cells to achieve a desirable heat dissipating effect.

The above figures and embodiments are provided by way of example only and, as such, those skilled in the art will appreciate that all obvious modifications and variations of the elements and arrangements set forth herein are to be considered as falling within the protective scope of the appended claims.

What is claimed is:

1. A battery pack for a cordless power tool, comprising:
a plurality of battery cells wherein at least one battery cell of the plurality of battery cells is partially provided with a phase change material; and
at least one bracket for supporting the plurality of battery cells;
wherein the phase change material is disposed at the maximum heat dissipating region of the at least one battery cell and the maximum heat dissipating region is a region extending from an intermediate position of the outer surface of the at least one battery cell towards a positive pole end of the at least one battery cell.

2. The battery pack according to claim 1, wherein the phase change material is configured to be annular and sleeved on the outer surface of the at least one battery cell.

3. The battery pack according to claim 2, wherein the phase change material is encapsulated on the at least one battery cell by an encapsulating layer.

4. The battery pack according to claim 3, wherein the phase change material disposed on the at least one battery cell has a weight of 1.5 g-3.5 g.

5. The battery pack according to claim 3, wherein the phase change material disposed on the at least one battery cell has a density of 1 kg/l-2 kg/l.

6. The battery pack according to claim 1, wherein the maximum heat dissipating region is located at a position of two-thirds in a longitudinal direction of the at least one battery cell extending from the intermediate position of the outer surface of the at least one battery cell towards the positive pole end.

7. The battery pack according to claim 1, wherein the maximum heat dissipating region is located at a position of three-fourths in a longitudinal direction of the at least one battery cell extending from the intermediate position of the outer surface of the at least one battery cell towards the positive pole end.

8. The battery pack according to claim 6, wherein the phase change material is further provided at a region extending towards a negative pole end and symmetrical with the maximum heat dissipating region with an intermediate point of the at least one battery cell being a symmetry point.

9. The battery pack according to claim 1, wherein the phase change material comprises fibrous material with a content of 0.5%-5%.

10. The battery pack according to claim 1, wherein the phase change material is filled one or more of a gap between the plurality of battery cells and a gap between the plurality of battery cells and the brackets.

11. The battery pack according to claim 10, wherein the battery pack further comprises at least two backing plates, and the phase change material is filled between the at least two backing plates.

12. The battery pack according to claim 11, wherein the backing plates support the plurality of battery cells and seal the phase change material.

13. The battery pack according to claim 12, wherein the at least two backing plates are provided with additional sealing material.

14. The battery pack according to claim 10, wherein the brackets seal the phase change material.

15. The battery pack according to claim 13, wherein the backing plates and the brackets are made of thermally conductive material.

16. A battery pack for a cordless power tool, comprising:
a plurality of battery cells;
a heat dissipating structure made of phase change material for dissipating heat from the plurality of battery cells, the heat dissipating structure being positioned solely on a predetermined region extending from an intermediate position of each battery cell towards pole ends of each battery cell wherein the predetermined region is a region of the battery cell with the largest heat generation and the quickest temperature rise; and
at least one bracket for supporting the plurality of battery cells.

17. The battery pack according to claim 16, wherein the phase change material comprises fibrous material with a content of 0.5%-5%.

18. The battery pack according to claim 16, wherein the heat dissipating structure is partially received in a gap between the plurality of battery cells or a gap between the plurality of battery cells and the brackets.
